(19) United States
(12) Patent Application Publication
(10) Pub. No.: US 2015/0358626 A1
(43) Pub. Date: Dec. 10, 2015

(54) IMAGE ENCODING APPARATUS, IMAGE ANALYZING APPARATUS, IMAGE ENCODING METHOD, AND IMAGE ANALYZING METHOD

(71) Applicant: MITSUBISHI ELECTRIC CORPORATION, Chiyoda-ku, Tokyo (JP)

(72) Inventor: Katsuhiro KUSANO, Tokyo (JP)

(73) Assignee: MITSUBISHI ELECTRIC CORPORATION, Chiyoda-ku, Tokyo (JP)

(21) Appl. No.: 14/762,750

(22) PCT Filed: Apr. 16, 2014
(86) PCT No.: PCT/JP2014/002146

§ 371 Date: Jul. 22, 2015

(30) Foreign Application Priority Data
Jun. 4, 2013 (JP) 2013-117726

(51) Int. Cl. H04N 19/176; H04N 19/44; H04N 19/159

(52) U.S. Cl. CPC H04N 19/176; H04N 19/159; H04N 19/44

(57) ABSTRACT

According to an image encoding apparatus, an image analyzing apparatus, an image encoding method, and an image analyzing method, the image encoding apparatus, on carrying out encoding, outputs encoded data to which texture encoded data which is made by encoding an image and additional information encoded data which is made by encoding additional information including information necessary for analyzing the image data are multiplexed, and the image analyzing apparatus demultiplexes the additional information encoded data from the encoded data, decodes the additional information encoded data, and analyzes the additional information. The image analysis is performed without decoding the texture encoded data, and thus the computation quantity related to the decoding process of the encoded data can be reduced.

### TECHNICAL FIELD

The present invention relates to an image encoding apparatus which encodes an image and an image analyzing apparatus which analyzes the image from the encoded data.

### BACKGROUND ART

Recent years, technique to compress and encode a video image has been widely used. As an encoding method of the video image, there are, for instance, MPEG-2 (Moving Picture Expert Group) method which is used for DVD (Digital Versatile Disk)-VIDEO, and MPEG-4 AVC (Advanced Video Coding)/ITU-T H.264 method which is used for a digital terrestrial broadcasting (one-segment broadcasting) for a mobile terminal or Blu-ray (Registered Trademark) Disk, and so on (for instance, Patent Literature 1).

Further, technique to analyze feature and motion of an image from image data has been used. For instance, such a technique extracts an object part from the image to track the motion of the object.

An image encoding apparatus carries out encoding using, for instance, the encoding method disclosed in Patent Literature 1, thereby compressing the data quantity of the video image; however, in order to analyze the image, the analysis should be done after decoding the encoded data into the image data by an image decoding apparatus.

### CITATION LIST

### Non-Patent Literature

Non-Patent Literature 1: MPEG-4 AVC(ISO/IEC 14496-10)/ITU-T H.264 Standard

### SUMMARY OF INVENTION

### Technical Problem

There is a problem in the conventional image analyzing apparatus that a large quantity of computation is required for the decoding process of the encoded data, since the analysis is done after decoding the encoded data into the image data by the image decoding apparatus.

The present invention is provided to solve the above problem; the invention aims to reduce computation quantity related to the decoding process of the encoded data by an image encoding apparatus which, on carrying out encoding, outputs encoded data which is made by multiplexing texture encoded data that is made by encoding an image and additional information encoded data that is made by encoding additional information including an auxiliary parameter of the image data; and an image analyzing apparatus which demultiplexes from the encoded data and decodes the additional information encoded data, and analyzes the additional information to analyze the image without decoding the texture encoded data.

### Solution to Problem

According to the present invention, an image encoding apparatus includes: a texture encoding unit which encodes a compressed image generated from an input image to generate texture encoded data; an additional information encoding unit which encodes additional information including information necessary for analyzing the input image to generate additional information encoded data; and a multiplexing unit which multiplexes the texture encoded data and the additional information encoded data to output an encoded stream.

According to the present invention, an image analyzing apparatus includes: a demultiplexing unit which demultiplexes additional information encoded data that is made by encoding additional information including information necessary for analyzing an image and texture encoded data that have been multiplexed to an encoded stream; an additional information decoding unit which decodes the additional information encoded data to generate the additional information; and an image analyzing unit which analyzes the image based on the information necessary for analyzing the image included in the additional information.

### Advantageous Effects of Invention

According to the present invention, on carrying out encoding, the image encoding apparatus is provided with the texture encoding unit which encodes texture, the additional information encoding unit which encodes the additional information used for encoding the texture, and the multiplexing unit which multiplexes the texture encoded data and the additional information encoded data to generate an encoded stream. The information necessary for analyzing the image is included in the additional information, and the image analysis can be done using only the additional information, so that the encoded stream from which the image can be analyzed using only the additional information can be generated.

Further, according to the present invention, on analyzing the image, the image analyzing apparatus is provided with the demultiplexing unit which demultiplexes the additional information encoded data and the texture encoded data that have been multiplexed to the encoded stream, the additional information decoding unit which decodes the additional information encoded data to generate the additional information, and the image analyzing unit which analyzes the image based on the additional information, and thus the image analysis can be done from the additional information including information necessary for the image analysis. The additional information encoded data is demultiplexed from the encoded stream and decoded into the additional information; and the image is analyzed, which eliminates the decoding process of the texture encoded data and reduces the computation quantity.

### BRIEF DESCRIPTION OF DRAWING

FIG. 1 is a configuration diagram illustrating an example of an image encoding apparatus related to a first embodiment of the present invention.

FIG. 2 is a configuration diagram illustrating an example of a compression unit of the image encoding apparatus related to the first embodiment of the present invention.

FIG. 3 is a configuration diagram illustrating an example of an extension unit of the image encoding apparatus related to the first embodiment of the present invention.

FIG. 4 illustrates an example of an encoded stream related to the first embodiment of the present invention.

FIG. 5 is a configuration diagram illustrating an example of an image analyzing apparatus related to a second embodiment of the present invention.

FIG. 6 is a flowchart illustrating an example of a clustering process based on an in-image prediction mode by an image analyzing unit of the image encoding apparatus related to the second embodiment of the present invention.

FIG. 7 is an explanatory diagram illustrating an example of the clustering process based on the in-image prediction mode by the image analyzing unit of the image encoding apparatus related to the second embodiment of the present invention.

FIG. 8 is an explanatory diagram illustrating an example of the clustering process of blocks having a size being different from a macroblock based on the in-image prediction mode by the image analyzing unit of the image encoding apparatus related to the second embodiment of the present invention.

FIG. 9 is a flowchart illustrating an example of the clustering process based on an inter-image prediction mode by the image analyzing unit of the image encoding apparatus related to the second embodiment of the present invention.

FIG. 10 is an explanatory diagram illustrating an example of the clustering process based on the inter-image prediction mode by the image analyzing unit of the image encoding apparatus related to the second embodiment of the present invention.

FIG. 11 is a configuration diagram illustrating an example of an image analyzing apparatus related to a third embodiment of the present invention.

FIG. 12 is a configuration diagram illustrating an example of an extension unit of the image analyzing apparatus related to the third embodiment of the present invention.

### DESCRIPTION OF EMBODIMENTS

Hereinafter, embodiments of an image encoding apparatus, an image analyzing apparatus, an image encoding method, and an image analyzing method related to the present invention will be explained in detail with reference to the drawings. Note that the present invention is not limited by the embodiments.

### Embodiment 1

The first embodiment of the present invention will explain an image encoding apparatus which, on carrying out encoding, multiplexes texture encoded data which is made by encoding texture and additional information encoded data which is made by encoding additional information that has been used for encoding the texture, and thereby information necessary for analyzing the image is included in the additional information, and an encoded stream from which the image can be analyzed using only the additional information is generated. The image encoding apparatus enables an image analyzing apparatus to demultiplex the additional information encoded data from the encoded stream and to analyze the image.

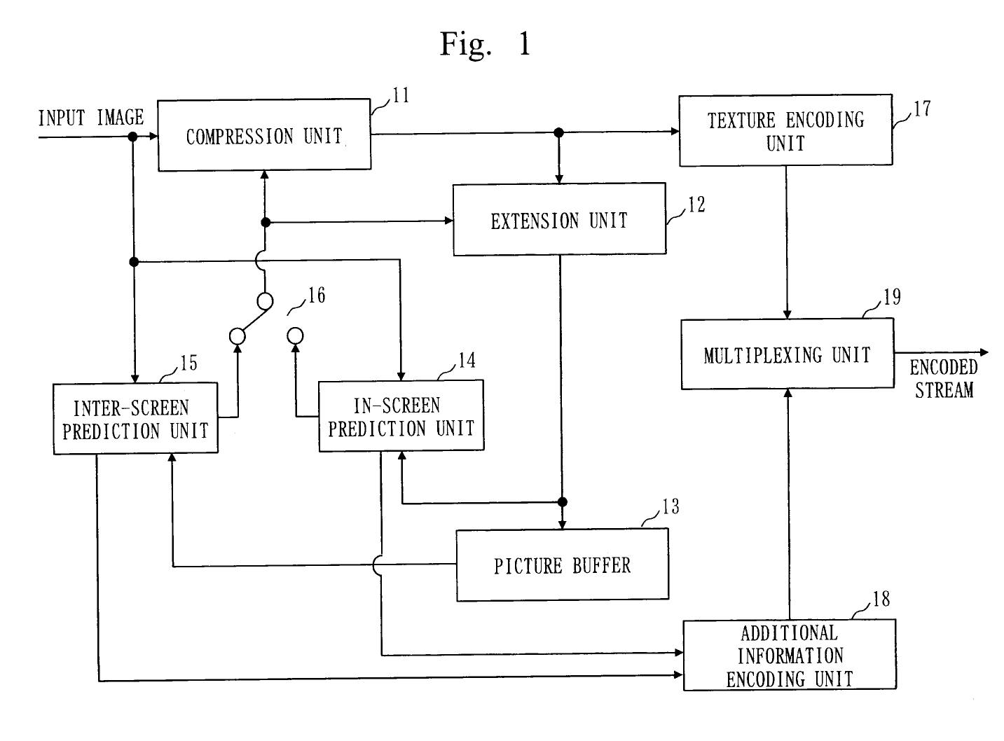

FIG. 1 is a configuration diagram illustrating an example of an image encoding apparatus related to the first embodiment of the present invention. In the figure, a compression unit 11 subtracts a prediction image from an input image to generate a compressed image. An extension unit 12 adds the prediction image to the compressed image generated by the compression unit 11 to generate a decoded image. An image storage unit (picture buffer) 13 stores, as storage means such as memories, the decoded image generated by the extension unit 12. An in-screen prediction unit 14 generates an in-screen prediction image from the input image and the decoded image generated by the extension unit 12 and outputs in-screen prediction additional information. An inter-screen prediction unit 15 generates an in-screen prediction image from the input image and the decoded image stored in the image storage unit (picture buffer) 13 to output inter-screen prediction additional information. A selection unit 16 selects, based on a prediction mode, one of the in-screen prediction image generated by the in-screen prediction unit 14 and the inter-screen prediction image generated by the inter-screen prediction unit 15 and sets the selected image as the prediction image. A texture encoding unit 17 encodes the compressed image generated by the compression unit 11 to generate texture encoded data. An additional information encoding unit 18 encodes additional information including the prediction mode, the in-screen prediction additional information output by the in-screen prediction unit 14, and the inter-screen prediction additional information output by the inter-screen prediction unit 15 and generates the additional information encoded data. A multiplexing unit 19 multiplexes the texture encoded data generated by the texture encoding unit 17 and the additional information encoded data generated by the additional information encoding unit 18 and outputs an encoded stream (encoded data). Here, the in-screen prediction unit 14, the inter-screen prediction unit 15, and the selection unit 16 can be united and deemed as a prediction image generation unit (prediction image generation means). The texture encoding unit 17 carries out an entropy encoding such as, for instance, Huffman encoding or the arithmetic encoding for the compressed image.

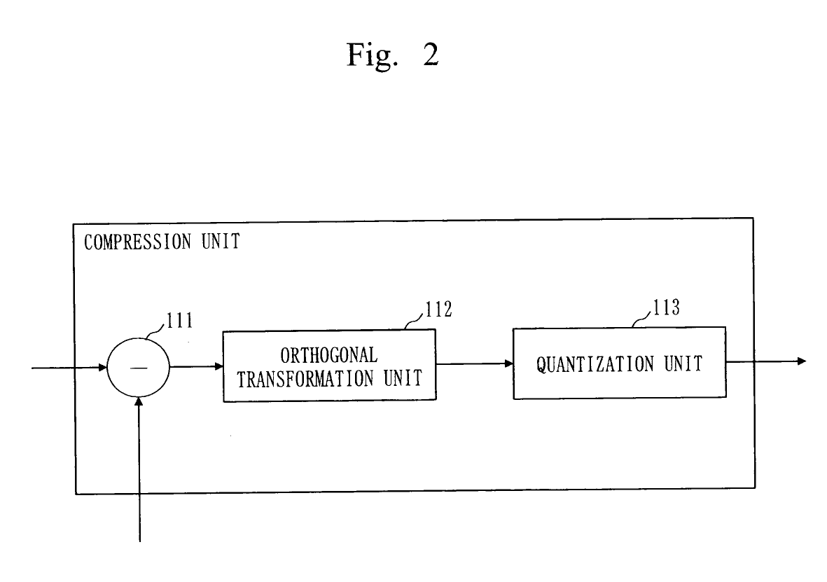

FIG. 2 is a configuration diagram illustrating an example of the compression unit of the image encoding apparatus related to the first embodiment of the present invention. The compression unit 11 configures compression means by a subtraction unit 111, an orthogonal transformation unit 112, and a quantization unit 113. In the figure, the subtraction unit 111 subtracts the prediction image selected by the selection unit 16, namely, the in-screen prediction image generated by the in-screen prediction unit 14 or the inter-screen prediction image generated by the inter-screen prediction unit 15 from the input image to generate a difference image. The orthogonal transformation unit 112 carries out an orthogonal transformation on the difference image and outputs an orthogonal transformation coefficient. The quantization unit 113 quantizes the orthogonal transformation coefficient to generate a compressed image.

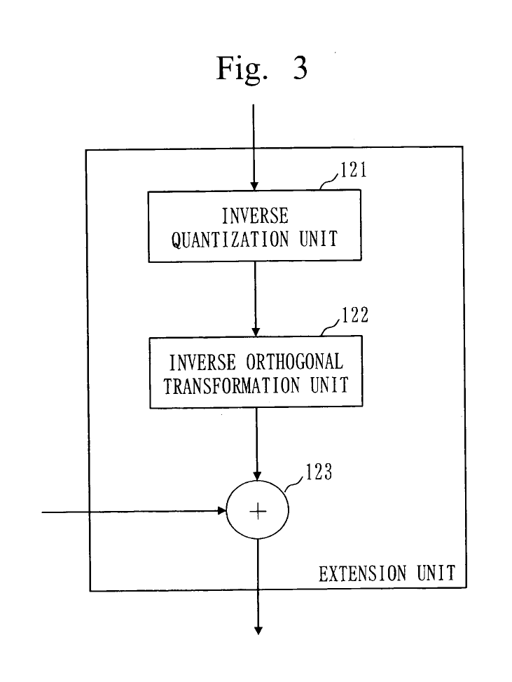

FIG. 3 is a configuration diagram illustrating an example of an extension unit of the image encoding apparatus related to the first embodiment of the present invention. The extension unit 12 configures extension means by an inverse quantization unit 121, an inverse orthogonal transformation unit 122, and an addition unit 123, and carries out an inverse transformation process with respect to the normal transformation process by the compression unit 11. In the figure, the inverse quantization unit 121 carries out an inverse quantization on the compressed image compressed by the compression unit 11, and outputs an orthogonal transformation coefficient. The inverse orthogonal transformation unit 122 carries out an inverse orthogonal transformation on the orthogonal transformation coefficient for which the inverse quantization has been carried out and outputs a difference image. The addition unit 123 adds the prediction image to the difference image for which the inverse orthogonal transformation has been carried out to generate a decoded image.

Note that the prediction image added by the extension unit 12 to the difference image for which the inverse orthogonal transformation has been carried out is the same image with the prediction image subtracted from the input image by the subtraction unit 111 of the compression unit 11. Further, as a deformed example, the processing units corresponding to the normal transformation and the inverse transformation can be eliminated in the orthogonal transformation unit 112 and the quantization unit 113 of the compression unit 11, and the inverse quantization unit 121 and the inverse orthogonal transformation unit 122 of the extension unit 12. For instance, the configuration may eliminate the orthogonal transformation unit 112 and the inverse orthogonal transformation unit 122, or the configuration may eliminate the quantization unit 113 and the inverse quantization unit 121. Yet further, all of the orthogonal transformation unit 112, the quantization unit 113, the inverse quantization unit 121, and the inverse orthogonal transformation unit 122 are eliminated; the compression unit 11 can be configured only by the subtraction unit 111, and the extension unit 12 can be configured only by the addition unit 123; if it is reversible, the configuration can be substantially eliminate the extension unit 12, and the equivalent result can be obtained by directly inputting the input image to store in the image storage unit 13.

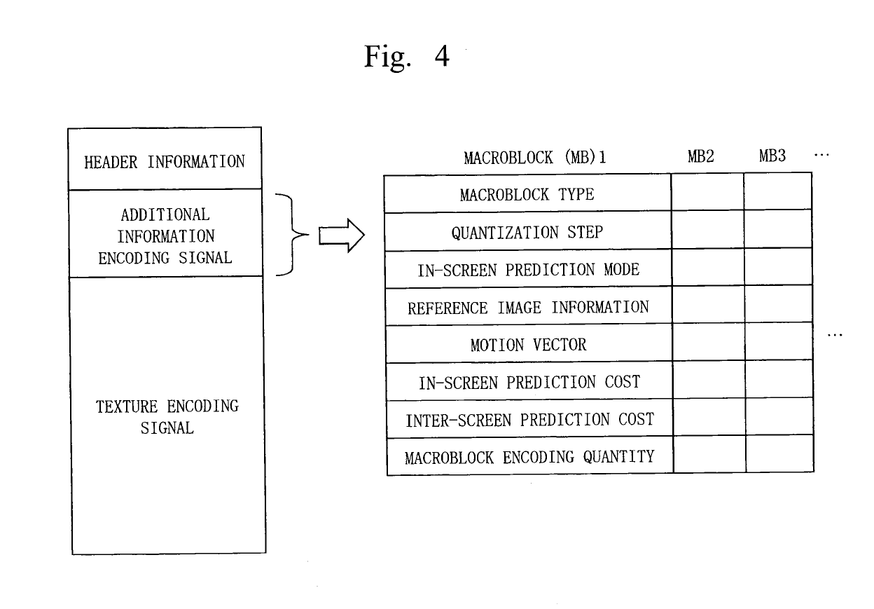

FIG. 4 illustrates an example of the encoded stream related to the first embodiment of the present invention. In the figure, the header information shows, for instance, SPS (Sequence Parameter Set: encoding information of sequence level) or PPS (Picture Parameter Set: picture-level encoding information) in H.264 encoding.

In H.264 encoding, prediction information and a quantization coefficient are encoded and multiplexed in units of 16×16 macroblock. In the first embodiment of the present invention, the prediction information is treated as a part of the additional information; for instance, the additional information encoded data which is made by encoding the additional information in units of 16×16 macroblock and the texture encoded data which is made by encoding the compressed image in units of 16×16 macroblock are separately encoded, and multiplexed.

In the additional information, data of information being essential for decoding such as a macroblock type, a quantization step, an in-screen prediction mode, reference image information, and a motion vector, and information being not always necessary for decoding such as an in-screen prediction cost, an inter-screen prediction cost, and macroblock encoding quantity, etc. are included. Note that, in order to perform efficient transmission or accumulation, the encoding is applied. Here, the additional information may include another kind of data that is not always necessary for decoding and is used for the image analysis, which has not been discussed above. For instance, a DC component of the orthogonal transformation coefficient or a PSNR (Peak Signal-to-Noise Ratio) can be encoded as the additional information. Here, among the additional information, for instance, the information being essential for decoding and the information being not always necessary for decoding may be individually encoded and multiplexed inside the additional information encoding unit 18 to generate the additional information encoded data.

Further, it has been explained that the in-screen prediction cost, the inter-screen prediction cost, and the macroblock encoding quantity which are unnecessary for decoding are encoded as the additional information encoded data. The information which is not always necessary for decoding may not be included in the additional information, but only the information being essential for decoding can be encoded as the additional information.

Here, the first embodiment has explained a case in which the texture encoding unit encodes the quantization coefficient and outputs the texture encoded data; another configuration can be done to encode pursuant to the standard and multiplex with the additional information encoded data so that the decoding can be carried out by a generally used image decoding apparatus. Further, as has been explained for deformed examples of the configuration of FIGS. 2 and 3, the configuration can be deformed to generate the encoded stream.

As has been discussed, according to the first embodiment, the image encoding apparatus is provided with the texture encoding unit which encodes the compressed image output by the compression unit and outputs the texture encoded data, the additional information encoding unit which encodes the additional information such as the in-screen prediction additional information, the inter-screen prediction additional information, the encoding quantity of the macroblock, and the like output when the encoding is done, and outputs the additional information encoded data, and the multiplexing unit which multiplexes the texture encoded data and the additional information encoded data. On encoding the image, the texture encoded data which is made by encoding the texture and the additional information encoded data which is made by encoding the additional information which has been used for encoding the texture are multiplexed, the information necessary for analyzing the image is included in the additional information, and the encoded stream from which the image can be analyzed only by the additional information can be generated. Further, the image analyzing apparatus which receives the encoded stream analyzes the image from the additional information that is decoded from the demultiplexed additional information encoded data, and thereby the computation quantity for decoding the texture encoded data can be reduced.

### Embodiment 2

The second embodiment of the present invention will explain an image analyzing apparatus which decodes the additional information encoded data which has been multiplexed to the encoded stream encoded by the image encoding apparatus of the first embodiment of the present invention and analyzes the image using the decoded additional information.

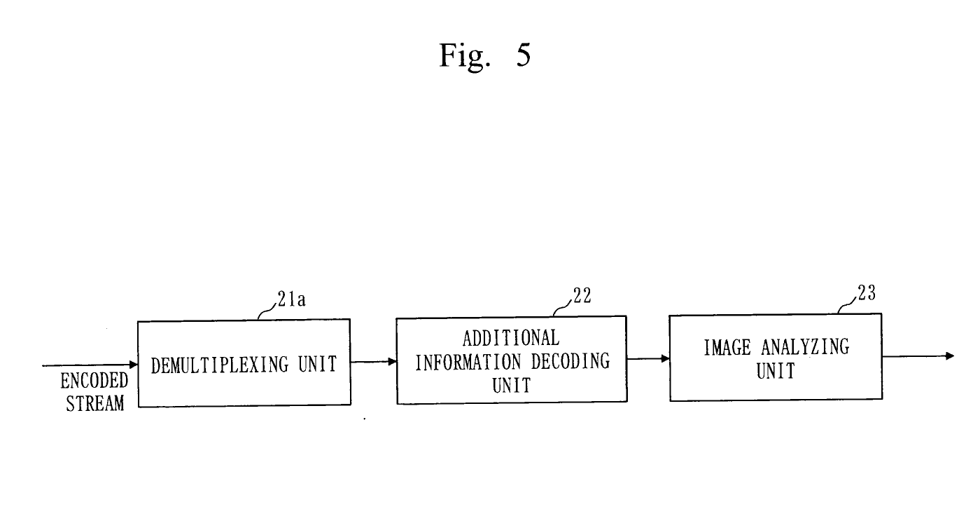

FIG. 5 is a configuration diagram illustrating an example of the image analyzing apparatus related to the second embodiment of the present invention. In the figure, a demultiplexing unit 21a demultiplexes the additional information encoded data and the texture encoded data that have been multiplexed to the encoded stream (encoded data) and outputs the additional information encoded data. An additional information decoding unit 22 decodes the additional information encoded data output from the demultiplexing unit 21a and generates the additional information. An image analyzing unit 23 analyzes the image based on the in-screen prediction additional information and the inter-screen prediction additional information included in the additional information generated by the additional information decoding unit 22 and generates an image analysis result. The image analysis result obtained by the image analyzing apparatus can be also used as auxiliary data for the image analysis by another image analyzing apparatus.

Here, among the additional information encoded data which is multiplexed to the encoded stream, the information being essential for decoding and the information being not always necessary for decoding are sometimes individually encoded. At this time, the additional information decoding unit 22 deals with the additional information encoded data demultiplexed by the demultiplexing unit 21a from the encoded stream, so that the encoded data of the information being essential for decoding and the information being not always essential for decoding should be separated and individually decoded, and so on. How to deal with the additional information encoded data can be decided beforehand between the image encoding apparatus and the image analyzing apparatus.

In the following, the operation of the image analyzing unit 23 will be explained.

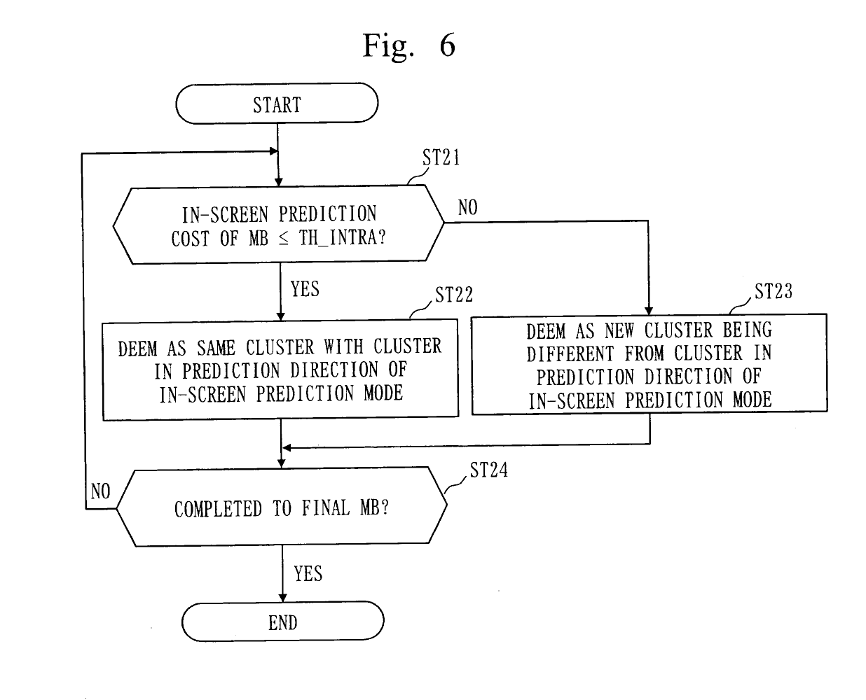

FIG. 6 is a flowchart illustrating an example of a clustering process based on an in-image prediction mode by the image analyzing unit of the image encoding apparatus according to the second embodiment of the present invention. Here, it is assumed to do the clustering process using the in-image prediction mode and an in-image prediction cost.

The image analyzing unit 23 discriminates, in each macroblock, whether or not an in-screen prediction cost of in-screen prediction additional information is equal to or less than a threshold value TH_INTRA (at step ST21).

If the in-screen prediction cost is equal to or less than the threshold value TH_INTRA (Yes), the current macroblock is set to a cluster being the same with a cluster in a prediction direction of the in-screen prediction mode (at step ST22). On the contrary, if the in-screen prediction cost is not equal to or less than the threshold value TH_INTRA (No), the current macroblock is set to a new cluster being different from the cluster in the prediction direction of the in-screen prediction mode (at step ST23).

The processes from step ST21 to step ST23 will be repeated until completing the processing of the final macroblock (at step ST24).

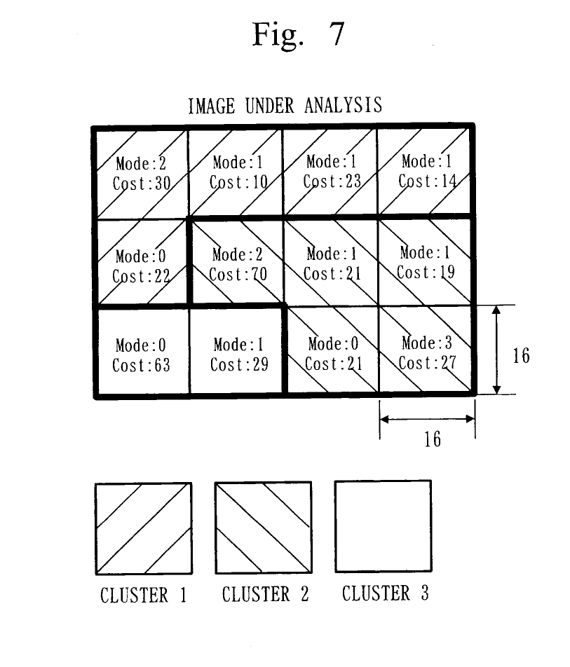

FIG. 7 is an explanatory diagram illustrating an example of the clustering process based on an in-image prediction mode by the image analyzing unit of the image encoding apparatus according to the second embodiment of the present invention. Here, an example of the image analysis using the clustering process by the 16×16 in-screen prediction mode (mode) and the in-screen prediction cost (cost) for each macroblock will be explained with reference to the flowchart of FIG. 6. Each illustrated quadrate represents 16×16 macroblock; the in-screen prediction mode and the in-screen prediction cost described within the quadrate are obtained by demultiplexing the additional information encoded data from the encoded stream by the demultiplexing unit 21a, and decoding the demultiplexed result for the macroblock by the additional information decoding unit 22.

As for the in-screen prediction mode, the mode 0 means a vertical prediction to calculate a prediction pixel from a pixel being adjacent to the top of the macroblock, the mode 1 means a horizontal prediction to calculate the prediction pixel from a pixel being adjacent to the left of the macroblock, the mode 2 means a DC prediction to calculate the prediction pixel from an average value of surrounding pixels, and the mode 3 means a Plane prediction to calculate the prediction pixel from the surrounding pixels.

Here, the explanation will be done by assuming that the left top is set as a reference, the scanning is done horizontally from the upper stage, the lower middle stage, and the bottom stage, and thereby clustering the macroblocks. The clusters of macroblock are classified into the cluster 1 indicated by falling diagonal strokes from top left to bottom right, the cluster 2 indicated by falling diagonal strokes from top right to bottom left, and the cluster 3 without strokes. Note that the threshold value TH_INTRA is set to, for instance, 30.

If the intra prediction cost is equal to or less than the threshold value TH_INTRA, in the mode 0, the macroblock is set to the cluster being the same with the macroblock which is adjacent to the top; in the mode 1, the macroblock is set to the cluster being the same with the macroblock which is adjacent to the left; in the mode 2 and the mode 3, when the upper macroblock and the left macroblock are the same cluster, the macroblock is set to the cluster being the same with the cluster of the upper and left macroblocks, and when the upper macroblock and the left macroblock are different clusters, the macroblock is set to a new cluster.

First, the first macroblock from the left of the upper stage is set to the first cluster 1 regardless of the in-screen prediction mode or the in-screen prediction cost. Next, as for the second macroblock, since the in-screen prediction cost value 10 is equal to or less than the threshold value TH_INTRA, the macroblock is set to the cluster 1 being the same with the cluster located in the left which is the prediction direction of the mode 1 of the in-screen prediction mode. Further, as for the third and the fourth macroblocks, similarly, since the in-screen prediction cost values 23 and 14 are equal to or less than the threshold value TH_INTRA, the macroblocks are set to the cluster 1 being the same with the cluster located in the left which is the prediction direction of the mode 1 of the in-screen prediction mode.

Subsequently, as for the first macroblock from the left of the middle stage, since the in-screen prediction cost value 22 is equal to or less than the threshold value TH_INTRA, the macroblock is set to the cluster 1 being the same with the cluster located in the above which is the prediction direction of the mode 0 of the in-screen prediction mode. Next, the second macroblock is, since the in-screen prediction cost value 70 is not equal to or less than the threshold value TH_INTRA, set to a new cluster 2. As for the third and fourth macroblocks, since the in-screen prediction cost values 21 and 19 are equal to or less than the threshold value TH_INTRA, the macroblocks are set to the cluster 2 being the same with the cluster located in the left which is the prediction direction of the mode 1 of the in-screen prediction mode.

Further, the first macroblock from the left in the bottom stage is, since the in-screen prediction cost value 63 is not equal to or less than the threshold value TH_INTRA, set to a new cluster 3. Next, as for the second macroblock, since the in-screen prediction cost value 29 is equal to or less than the threshold value TH_INTRA, the macroblock is set to the cluster 3 being the same with the cluster located in the left which is the prediction direction of the mode 1 of the in-screen prediction mode. As for the third macroblock, since the in-screen prediction cost value 21 is equal to or less than the threshold value TH_INTRA, the macroblock is set to the cluster 2 being the same with the cluster located in the above which is the prediction direction of the mode 0 of the in-screen prediction mode. As for the fourth macroblock, since the in-screen prediction cost value 27 is equal to or less than the threshold value TH_INTRA, the macroblock is set to the cluster 2, since the in-screen prediction mode is the mode 3 and the upper and left macroblocks are the same cluster 2.

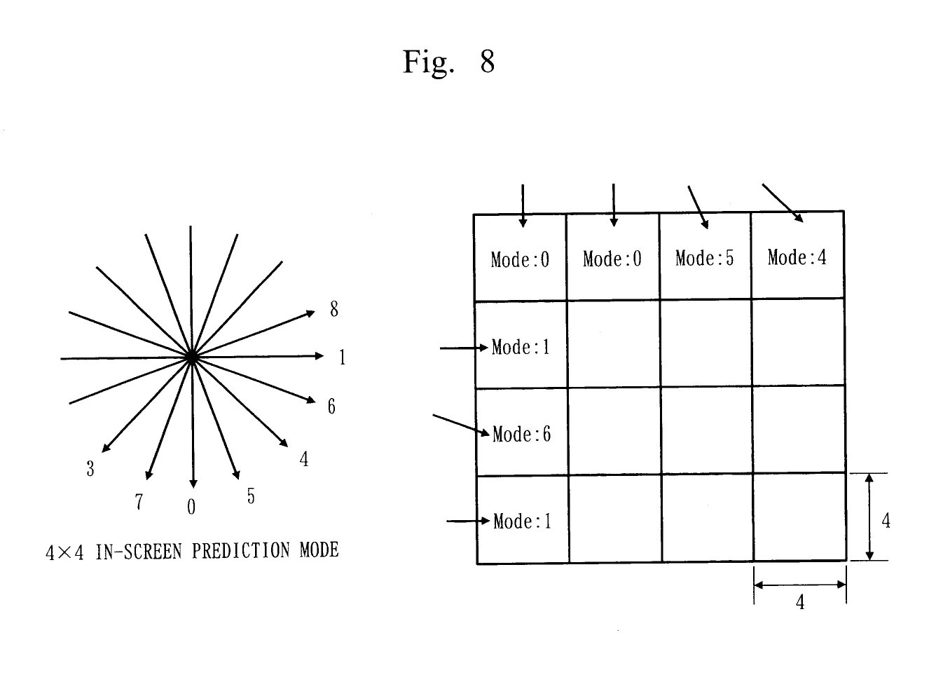

FIG. 8 is an explanatory diagram illustrating an example of clustering process of blocks having sizes being different from the macroblocks based on the in-image prediction mode by the image analyzing unit of the image encoding apparatus according to the second embodiment of the present invention. Here, an example of selection of the cluster will be explained in a case where the in-screen prediction cost is equal to or less than the threshold value TH_INTRA and the 4×4 in-screen prediction mode is used. In the figure, the left drawing illustrates correspondence between the referencing direction of pixels and the mode number in the 4×4 in-screen prediction mode. The right drawing illustrates a case where the 16×16 macroblock (large block) is divided into, for instance, sixteen 4×4 blocks (small block) consisting of four blocks vertically and horizontally; and the in-screen prediction mode is described in the uppermost and leftmost 4×4 blocks. Arrows at the block boundary represents referencing direction of the pixels corresponding to the prediction mode illustrated in the left drawing. The mode 2 is, similarly to the 16×16 in-screen prediction, the DC prediction to calculate the prediction pixel from the average value of the surrounding pixels, and the referencing direction is deemed to be the same with the mode 4 in the second embodiment of the present invention. It is assumed that the 4×4 in-screen prediction mode in the figure is made by demultiplexing the additional information encoded data from the encoded stream by the demultiplexing unit 21a and decoding the additional information encoded data by the additional information decoding unit 22 for the macroblock. The encoded block size is described in the macroblock type information included in the additional information as the information essential for decoding.

Here, the 16×16 macroblock is set to the same cluster with the one including pixels referenced by many 4×4 blocks in the direction of, for instance, the prediction mode of the uppermost and leftmost seven 4×4 blocks. In this example, since the prediction from the macroblock being adjacent to the top is many, the cluster of the macroblock is set to the same cluster of the upper macroblock.

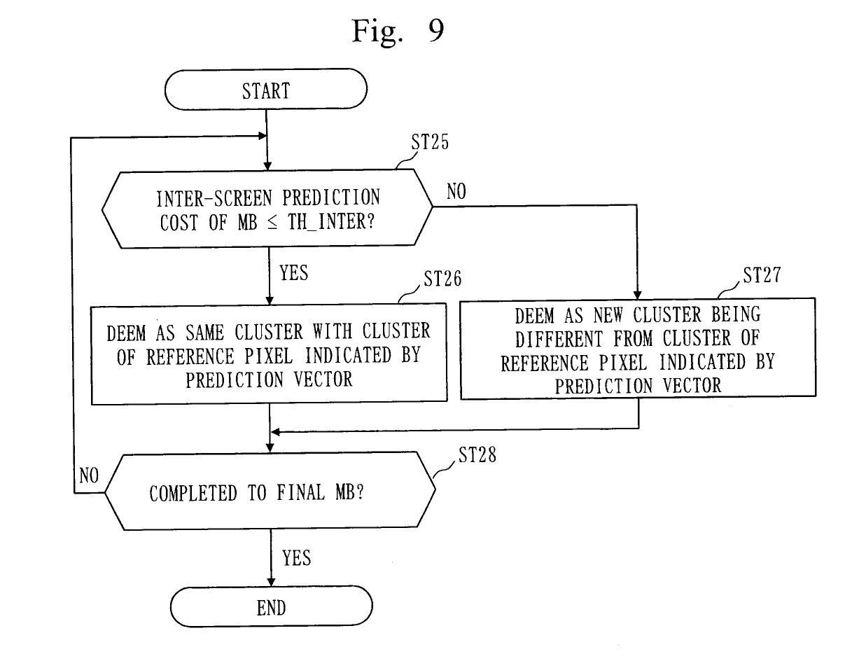

FIG. 9 is a flowchart illustrating an example of the clustering process based on the inter-image prediction mode by the image analyzing unit of the image encoding apparatus according to the second embodiment of the present invention. Here, the clustering process is carried out using the reference image information, the motion vector, and the inter-image prediction cost.

The image analyzing unit 23 discriminates, in each macroblock, among the inter-screen prediction additional information, whether or not the inter-screen prediction cost is equal to or less than the threshold value TH_INTER (at step ST25).

If the in-screen prediction cost is equal to or less than the threshold value TH_INTER (Yes), the current macroblock is set to the cluster being the same with the cluster of the reference image indicated by the motion vector (at step ST26). On the contrary, if the inter-screen prediction cost is not equal to or less than the threshold value TH_INTER (No), the current macroblock is set to a new cluster being different from the cluster of the reference image indicated by the motion vector (at step ST27).

The process from step ST25 to step ST27 will be repeated until the processing of the final macroblock is completed (at step ST28).

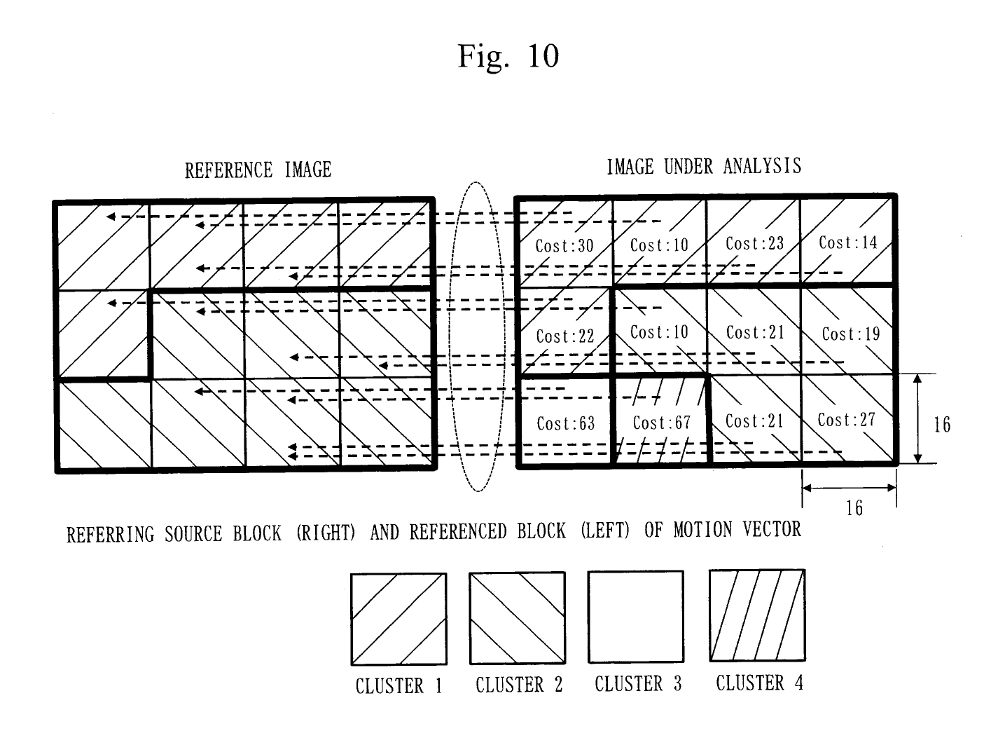

FIG. 10 is an explanatory diagram illustrating an example of the clustering process based on the inter-image prediction mode by the image analyzing unit of the image encoding apparatus according to the second embodiment of the present invention. Here, an example of the image analysis by the clustering process using the reference image information, the motion vector, and the inter-screen prediction cost (Cost) for each macroblock will be explained based on a flowchart of FIG. 9. At this time, the reference image information is information showing which image of the images that were already analyzed in the past is referenced by the macroblock being currently analyzed. Note that an arrow of broken line represents information of macroblock level showing which macroblock including a pixel referenced by a motion vector of the macroblock under analysis, and the arrow of broken line does not indicate a correct pixel position actually referenced by the motion vector. Here, it is assumed the arrow of broken line indicates the motion vector. Each illustrated quadrate represents 16×16 macroblock; the inter-screen prediction cost described within the image under analysis is decoded for the macroblock by the additional information decoding unit 22 from the additional information encoded data demultiplexed by the demultiplexing unit 21a from the encoded stream.

Here, the explanation will be done by assuming that the left top is set as a reference, the scanning is done horizontally from the upper stage, the lower middle stage, and bottom stage, and thereby clustering the macroblocks. The clusters of the macroblock are classified into the cluster 1 indicated by falling diagonal strokes from top right to bottom left, the cluster 2 indicated by falling diagonal strokes from top left to bottom right, the cluster 3 without strokes, and the cluster 4 indicated by steep falling diagonal strokes from top right to bottom left. Note that the threshold value TH_INTRA is set to, for instance, 30.

First, the first macroblock from the left of the upper stage is, since the inter-screen prediction cost value 30 is equal to or less than the threshold value TH_INTER, set to the cluster 1 being the same with the cluster of the reference image indicated by the motion vector. Similarly, the second, the third, the fourth macroblocks are, since the inter-screen prediction costs are equal to or less than the threshold value TH_INTER, also set to the cluster 1 being the same with the cluster of the reference images indicated by the motion vectors.

Subsequently, the first macroblock from the left of the middle stage is, since the inter-screen prediction cost value 22 is equal to or less than the threshold value TH_INTER, set to the cluster 1 being the same with the cluster of the reference image indicated by the motion vector. Next, the second macroblock is, since the inter-screen prediction cost value 10 is equal to or less than the threshold value TH_INTER, set to the cluster 2 being the same with the cluster of the reference image indicated by the motion vector. The third and the fourth macroblocks are, similarly, since the in-screen prediction cost values 21 and 19 are equal to or less than the threshold value TH_INTER, set to the cluster 2 being the same with the clusters of the reference images indicated by the motion vectors.

Further, the first macroblock from the left of the bottom stage is, since the in-screen prediction cost value 63 is not equal to or less than the threshold value TH_INTER, set to a new cluster 3. Next, the second macroblock is, since the in-screen prediction cost value 67 is not equal to or less than the threshold value TH_INTER, set to a new cluster 4. The third and the fourth macroblocks are, since the in-screen prediction cost values 21 and 27 are equal to or less than the threshold value TH_INTER, set to the cluster 2 being the same with the cluster of the reference images indicated by the motion vectors.

The image analyzing process such as the clustering for the macroblock of the image which has been discussed above is carried out, and thereby the image analyzing unit 23 of the image analyzing apparatus outputs the image analyzed result.

Here, the second embodiment has explained a case in which the image is analyzed using the in-screen prediction cost and the inter-screen prediction cost; however, the second embodiment can be configured to analyze the image using, for instance, the macroblock encoding quantity and the quantization step.

For instance, a value obtained by multiplying the quantization step to the macroblock encoding quantity is deemed as the in-screen prediction cost or the inter-screen prediction cost according to the encoding system. The prediction cost is compared with the threshold value; if the compared result is equal to or less than the threshold value, the cluster can be set to the same cluster in the in-screen prediction mode indicated by the motion vector, and if it is not equal to or less than the threshold value, the cluster can be set to a new cluster. Here, at this time, for instance, the prediction cost which is obtained by multiplying the quantization step to the macroblock encoding quantity and adjusted by further multiplying an adjustment factor which varies according to the encoding system can be compared with the common threshold value, or the prediction cost which is obtained by the common formula for calculating a value by multiplying the quantization step to the macroblock encoding quantity can be also compared with a threshold value which varies according to the encoding system.

As has been discussed, according to the second embodiment, the image analyzing apparatus is provided with the demultiplexing unit which demultiplexes the additional information encoded data and the texture encoded data that have been multiplexed to the received encoded stream, the additional information decoding unit which decodes the demultiplexed additional information encoded data and outputs the additional information, and the image analyzing unit which analyzes the image using the additional information. The image analysis can be performed without decoding the texture encoded data to obtain the image, and thereby the computation quantity for analyzing the image can be reduced.

### Embodiment 3

The above second embodiment of the present invention has explained the image analyzing apparatus which decodes the additional information encoded data that has been multiplexed to the encoded stream and analyzes the image using the decoded additional information. The third embodiment of the present invention will explain the image analyzing apparatus which decodes the texture encoded data that has been multiplexed to obtain the decoded image in addition to the image analysis carried out in the second embodiment of the present invention.

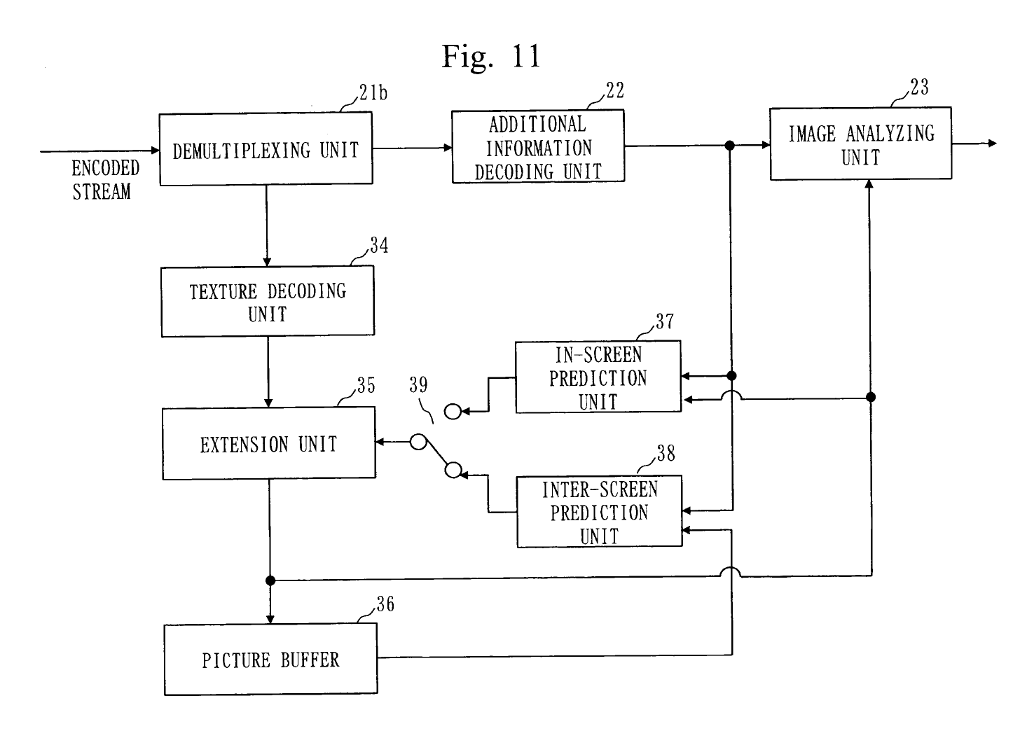

FIG. 11 is a configuration diagram showing an example of the image analyzing apparatus related to the third embodiment of the present invention. In the figure, since the configuration component indicated by the same sign with FIG. 5 represents the same or the corresponding part, the explanation will be omitted. In the figure, a demultiplexing unit 21b demultiplexes additional information encoded data and texture encoded data that have been multiplexed to an encoded stream and outputs additional information encoded data and texture encoded data. A texture decoding unit 34 decodes the texture encoded data demultiplexed by the demultiplexing unit 21b and generates a compressed image. An extension unit 35 adds a prediction image to the compressed image generated by the texture decoding unit 34 and generates a decoded image. An image storage unit (picture buffer) 36 stores, as storage means such as memories, the decoded image generated by the extension unit 35. An in-screen prediction unit 37 generates an in-screen prediction image from the decoded image generated by the extension unit 35 based on in-screen prediction additional information included in the additional information generated by the additional information decoding unit 22. An inter-screen prediction unit 38 generates an in-screen prediction image from the decoded image stored in the image storage unit (picture buffer) 36 based on inter-screen prediction additional information included in the additional information generated by the additional information decoding unit 22. A selection unit 39 selects one of the in-screen prediction image generated by the in-screen prediction unit 37 and the inter-screen prediction image generated by the inter-screen prediction unit 38 based on a prediction mode included in the additional information generated by the additional information decoding unit 22 and sets the selected image as the prediction image. Here, in order of pictures of the input image received by the image encoding apparatus which generates the encoded stream, the decoded images stored in the image storage unit (picture buffer) 36 can be output and reproduced by a display unit (not illustrated) such as a display. The texture decoding unit 34 is assumed to perform the decoding system corresponding to the encoding system employed by the image encoding apparatus, for instance, the entropy decoding such as Huffmann decoding, the arithmetic decoding, and the like. Further, the in-screen prediction unit 37, the inter-screen prediction unit 38, and the selection unit 39 can be united and deemed as a prediction image generation unit (prediction image generation means).

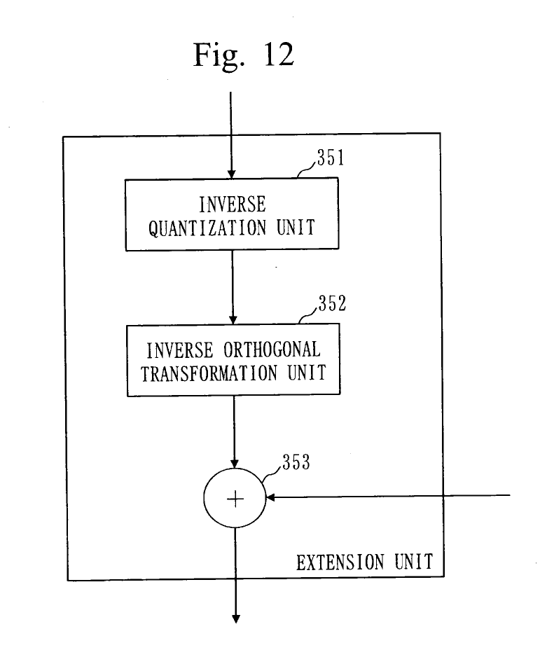

FIG. 12 is a configuration diagram illustrating an example of the extension unit of the image analyzing apparatus related to the third embodiment of the present invention. The extension unit 35 of the image analyzing apparatus corresponds to the extension unit 12 of the image encoding apparatus related to the first embodiment of the present invention illustrated in FIG. 3; and since the operation is the same as the one having the same component name, the explanation will be omitted. Further, in a case where the configuration is deformed by the deformed example that has been explained for the compression unit and the extension unit 12 of the image encoding apparatus 11 related to the first embodiment of the present invention, the extension unit 35 of the image analyzing apparatus should be matched to the deformed configuration of the extension unit 12.

The image analyzing apparatus according to the third embodiment of the present invention can be configured as an image decoding apparatus having the image analyzing apparatus according to the second embodiment of the present invention as the image analysis means which analyzes the image based on the additional information encoded data demultiplexed from the encoded stream encoded by the image encoding apparatus according to the first embodiment.

As has been discussed, according to the third embodiment, the image analyzing apparatus is provided with the demultiplexing unit which demultiplexes the additional information encoded data and the texture encoded data that have been multiplexed to the received encoded stream, the additional information decoding unit which decodes the demultiplexed additional information encoded data and outputs the additional information, and the image analyzing unit which analyzes the image using the additional information. The image analysis can be performed without decoding the texture encoded data to obtain the image, and thereby the computation quantity for analyzing the image can be reduced.

Further, according to the third embodiment, the image analyzing apparatus is provided with the demultiplexing unit which demultiplexes the additional information encoded data and the texture encoded data that have been multiplexed to the received encoded stream, and the texture decoding unit 34 which decodes the texture encoded data, and thus the decoded image, for which the image analysis has been carried out, can be obtained.

### INDUSTRIAL APPLICABILITY

As has been discussed, according to the image encoding apparatus, the image analyzing apparatus, the image encoding method, and the image analyzing method related to the present invention, the image encoding apparatus, on carrying out encoding, multiplexes the texture encoded data which is made by encoding the image and the additional information encoded data which is made by encoding the additional information including information being necessary for analyzing the image and outputs the multiplexed data as the encoded data. Then, the image analyzing apparatus demultiplexes the additional information encoded data from the encoded data, decodes the additional information encoded data, and analyzes the image based on the additional information, and thereby the computation quantity related to the decoding process of the texture encoded data can be reduced.

### REFERENCE SIGNS LIST

11: compression unit; 12: extension unit; 13: image storage unit (picture buffer); 14: in-image prediction unit; 15: inter-image prediction unit; 16: selection unit (switch); 17: texture encoding unit; 18: additional information encoding unit; 19: multiplexing unit; 21a, 21b: demultiplexing unit; 22: additional information decoding unit; 23: image analyzing unit; 34: texture decoding unit; 35: extension unit; 36: image storage unit (picture buffer); 37: in-image prediction unit; 38: inter-image prediction unit; 39: selection unit (switch), 111: subtraction unit; 112: orthogonal transformation unit; 113: quantization unit; 121: inverse quantization unit; 122: inverse orthogonal transformation unit; 123: addition unit; 351: inverse quantization unit; 352: inverse orthogonal transformation unit; and 353: addition unit.

1. An image encoding apparatus comprising:
a texture encoding unit which encodes each of a plurality of macroblocks of a compressed image generated from an input image to generate texture encoded data;
an additional information encoding unit which encodes additional information for each of the plurality of macroblocks, including information necessary for analyzing the input image to generate additional information encoded data; and
a multiplexing unit which multiplexes the texture encoded data and the additional information encoded data so as to be demultiplexed separately with each other to output an encoded stream.

2. The image encoding apparatus of claim 1, further comprising:
a compression unit which subtracts a prediction image from the input image to generate the compressed image;
an extension unit which adds the prediction image to the compressed image to generate a decoded image; and
an in-screen prediction unit which generates an in-screen prediction image from the input image and the decoded image generated by the extension unit to output in-screen prediction additional information including information of an in-screen prediction cost and an in-screen prediction mode for each macroblock,
wherein the additional information includes the in-screen prediction additional information.

3. The image encoding apparatus of claim 2, wherein the information of the in-screen prediction mode included in the in-screen prediction additional information includes macroblock type information.

4. The image encoding apparatus of claim 1, further comprising:
an image storage unit which stores a decoded image that is generated by adding the prediction image to the compressed image that is generated by subtracting the prediction image from the input image; and
an inter-screen prediction unit which generates an inter-screen prediction image from the input image and the decoded image stored in the image storage unit to output inter-screen prediction additional information including information of an inter-screen prediction cost and a motion vector for each macroblock,
wherein the additional information includes the inter-screen prediction additional information.

5. The image encoding apparatus of claim 1, wherein the additional information encoded data includes information of macroblock encoding quantity and quantization step for each macroblock.

6. An image analyzing apparatus comprising:
a demultiplexing unit which demultiplexes additional information encoded data that is made by encoding additional information for each of a plurality of macroblocks, including information necessary for analyzing an image and texture encoded data for each of the plurality of macroblocks, which has been multiplexed so as to be demultiplexed separately from the additional information encoded data, that have been multiplexed to an encoded stream;
an additional information decoding unit which decodes the additional information encoded data to generate the additional information; and
an image analyzing unit which analyzes the image based on the information necessary for analyzing the image included in the additional information.

7. The image analyzing apparatus of claim 6 comprising:
a texture decoding unit which decodes the texture encoded data to generate a compressed image;
an extension unit which adds a prediction image to the compressed image to generate a decoded image;
an image storage unit which stores the decoded image;
an in-screen prediction unit which generates an in-screen prediction image from the decoded image generated by the extension unit based on in-screen prediction additional information included in the additional information;
an inter-screen prediction unit which generates an inter-screen prediction image from the decoded image stored in the image storage unit based on the inter-screen prediction additional information included in the additional information; and
a selection unit which selects one of the in-screen prediction image and the inter-screen prediction image based on a prediction mode included in the additional information to set the selected image as the prediction image.

8. The image analyzing apparatus of claim 6, wherein
the inter-screen additional information includes information of an in-screen prediction cost and an in-screen prediction mode for each macroblock, and
the image analyzing unit, if the in-screen prediction cost of the macroblock is equal to or less than a threshold value, classifies the macroblock to a same cluster with a cluster to which a macroblock in a prediction direction of the in-screen prediction mode belongs, and if the in-screen prediction cost is not equal to or less than the threshold value, classifies the macroblock to a new cluster.

9. The image analyzing apparatus of claim 8, wherein
the information of the prediction mode included in the in-screen additional information includes macroblock type information, and
the image analyzing unit, based on the macroblock type information, in a case where the macroblock is encoded in units of small blocks which have been made by further segmentizing the macroblock, classifies the macroblock to a same cluster including a largest number of reference pixels based on a prediction direction of the in-screen prediction mode of the small blocks of the macroblock that is contacted to a macroblock that has been already classified to a cluster.

10. The image analyzing apparatus of claim 6, wherein
the inter-screen additional information includes information of an inter-screen prediction cost and a motion vector for each macroblock, and
the image analyzing unit, if the inter-screen prediction cost of the macroblock is equal to or less than a threshold value, classifies the macroblock to a same cluster with a cluster to which a reference pixel indicated by the motion vector belongs, and if it is not equal to or less than the threshold value, classifies the macroblock to a new cluster.

11. The image analyzing apparatus of claim 6, wherein
the additional information includes information of macroblock encoding quantity and a quantization step for each macroblock, and
the image analyzing unit, if a cost calculated using the macroblock encoding quantity and the quantization step of the macroblock is equal to or less than a threshold value, in a case where the macroblock is encoded by an in-screen prediction encoding, classifies the macroblock to a same cluster with a cluster to which a macroblock in a prediction direction of an in-screen prediction mode belongs to, in a case where the macroblock is encoded by an inter-screen prediction encoding, classifies the macroblock to a same cluster with a cluster to which a reference pixel indicated by a motion vector belongs, and if the cost is not equal to or less than the threshold value, classifies the macroblock to a new cluster.

12. An image encoding method of an image encoding apparatus that encodes an image, the image encoding method comprising:
encoding each of a plurality of macroblocks of a compressed image generated from a received image to generate texture encoded data;
encoding additional information for each of the plurality of macroblocks, including information necessary for analyzing the image to generate additional information encoded data; and
multiplexing the texture encoded data and the additional information encoded data so as to be demultiplexed separately with each other to output an encoded stream.

13. An image analyzing method comprising:
demultiplexing additional information encoded data that is made by encoding additional information for each of a plurality of macroblocks, including information necessary for analyzing an image and texture encoded data for each of the plurality of macroblocks, which has been multiplexed so as to be demultiplexed separately from the additional information encoded data, that have been multiplexed to the encoded stream;
decoding the additional information encoded data to generate the additional information; and
analyzing the image based on the information necessary for analyzing the image included in the additional information.

14. The image analyzing method of claim 13 comprising:
decoding the texture encoded data to generate a compressed image,
adding a prediction image to the compressed image to generate a decoded image;
storing the decoded image in storage means;
generating an in-screen prediction image from the decoded image generated by the adding based on in-screen prediction additional information included in the additional information;
generating an inter-screen prediction image from the decoded image stored in the storage means by the storing based on inter-screen prediction additional information included in the additional information; and
selecting one of the in-screen prediction image and the inter-screen prediction image based on a prediction mode included in the additional information to set the selected image as the prediction image.
